(19) United States
(12) Patent Application Publication
(10) Pub. No.: US 2018/0057347 A1
(43) Pub. Date: Mar. 1, 2018

(54) SYSTEMS AND METHODS FOR FUELING A VEHICLE WITH A FUEL DELIVERY SERVICE

(71) Applicant: GENERAL MOTORS LLC, Detroit, MI (US)

(72) Inventors: CHRISTOPHER L. OESTERLING, TROY, MI (US); PAUL H. PEBBLES, NOVI, MI (US); DANA B. FECHER, FARMINGTON HILLS, MI (US); JEFFREY M. STEFAN, CLAWSON, MI (US)

(73) Assignee: GENERAL MOTORS LLC, Detroit, MI (US)

(21) Appl. No.: 15/250,321

(22) Filed: Aug. 29, 2016

(51) Int. Cl. B67D 7/06; B67D 7/04; G07C 5/00; G06Q 10/10

(52) U.S. Cl. CPC B67D 7/067; B67D 7/04; H04L 67/125; G07C 5/008; G06Q 10/1093; B67D 7/065

(57) ABSTRACT

Systems and methods are provided for fueling a vehicle with a fuel delivery service. A telematics unit is adapted for installation on the vehicle and configured to determine a fuel level of the vehicle. A remote server has a database of vehicle scheduling information and is configured to transmit a fueling request to the fuel delivery service. The telematics unit is further configured to transmit a vehicle fueling request to the remote server based on the fuel level of the vehicle. The remote server is further configured to transmit the fueling request based on the vehicle fueling request and the vehicle scheduling information.

### TECHNICAL FIELD

The technical field generally relates to vehicle fueling systems, and more particularly relates to systems and methods for automatically fueling shared fleet vehicles with a fuel delivery service.

### BACKGROUND

Vehicle sharing and self-serve vehicle rental services allow customers to make reservations for station based round trip use of vehicles, particularly in urban environments. Typically, customers are responsible for refueling the vehicles prior to returning the vehicle at the end of their reservation. Generally, either the customer has to pay a surcharge for the fuel if the vehicle is returned with less fuel than required or the vehicle sharing company supplies a fuel card in each vehicle as well as the instructions for refueling at the gas station. Either of these solutions takes time and effort for the customer. It also requires the vehicle sharing company resources to manage gas cards, support, the customer, etc. If a customer does not refuel a vehicle when needed then the next customer will be dissatisfied having to get fuel before even starting their trip. Customers may even have to extend their reservation to refuel the vehicle. This can frustrate both the current and future customers and prevent vehicle sharing service from operating efficiently.

Fuel delivery services provide customers with fuel delivery to a specific location or vehicle. These fuel delivery services are particularly well suited to urban environments where gas stations are hard to come by. Typically, customers request a fuel delivery by contacting the fuel delivery service by phone call, using an app on a mobile device, accessing a website, etc., and scheduling a delivery. The customer is responsible for selecting the type of fuel, the amount needed, the timeframe in which the fuel is needed, and must further unlock the fuel door. Accordingly, these fuel delivery systems can be difficult to use with a fleet of vehicles, especially when vehicles are being used at sporadic times. Furthermore, managing a fuel delivery service for a fleet of vehicles would require significant resource management on the part of the vehicle sharing company.

Accordingly, it is desirable to provide systems and methods for fueling a vehicle. It is additionally desirable to automatically manage the fueling of shared vehicles so that the customer is not responsible for fueling the vehicle. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for fueling a vehicle with a fuel delivery service.

In one non-limiting example, a system for fueling a vehicle with a fuel delivery service includes, but is not limited to, a telematics unit adapted for installation on the vehicle and configured to determine a fuel level of the vehicle. The system further includes, but is not limited to, a remote server having a database of vehicle scheduling information. The remote server is configured to transmit a fueling request to the fuel delivery service. The telematics unit is further configured to transmit a vehicle fueling request to the remote server based on the fuel level of the vehicle. The remote server is further configured to transmit the fueling request based on the vehicle fueling request and the vehicle scheduling information.

In another non-limiting example, a method is provided for fueling a vehicle with a fuel delivery service. The method includes, but is not limited to, monitoring, by a telematics unit on the vehicle, a fuel level of the vehicle. The method further includes, but is not limited to, transmitting, by the telematics unit, a vehicle fueling request to a remote server based on the fuel level of the vehicle. The method further includes, but is not limited to, receiving, by the remote server, the vehicle fueling request. The method further includes, but is not limited to, transmitting, by the remote server, a fueling request to the fuel delivery service. The fueling request is based on the vehicle fueling request and a vehicle scheduling information corresponding to the vehicle.

### DESCRIPTION OF THE DRAWINGS

The disclosed examples will hereinafter be described in conjunction with the following drawing figures, wherein like numerals denote like elements, and wherein:

FIG. 1 is a diagram illustrating a non-limiting example of a communication system;

FIG. 2 is a diagram illustrating a non-limiting example of a system for fueling a vehicle with a fuel delivery service according to an embodiment;

FIG. 3 is a diagram illustrating a non-limiting example of a system for fueling a vehicle with a fuel delivery service according to an embodiment;

FIG. 4 is a flowchart illustrating a non-limiting example of a method for fueling a vehicle with a fuel delivery service; and

FIG. 5 is a flowchart illustrating a non-limiting example of a method for fueling a vehicle with a fuel delivery service

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

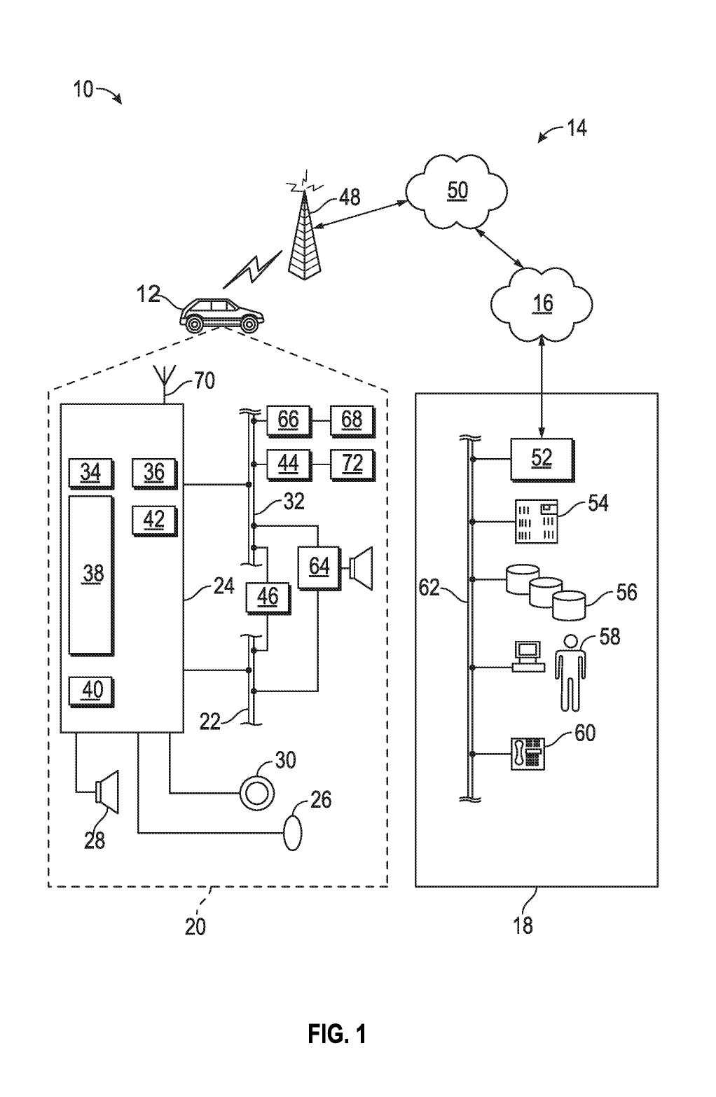

With reference to FIG. 1, there is shown a non-limiting example of a communication system 10 that may be used together with examples of the apparatus/system disclosed herein or to implement examples of the methods disclosed herein. Communication system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GNSS chipset/component 42. In one example, the wireless modem 36 includes a computer program and/or set of software routines adapted to be executed within electronic processing device 38.

The telematics unit 24 may provide various services including: turn-by-turn directions and other navigation-related services provided in conjunction with the GNSS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc.

Dual mode antenna 70 services the GNSS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a call center 18 that is manned, it will be appreciated that the call center 18 can be any central or remote facility, manned or unmanned, mobile or fixed, to or from which it is desirable to exchange voice and data.

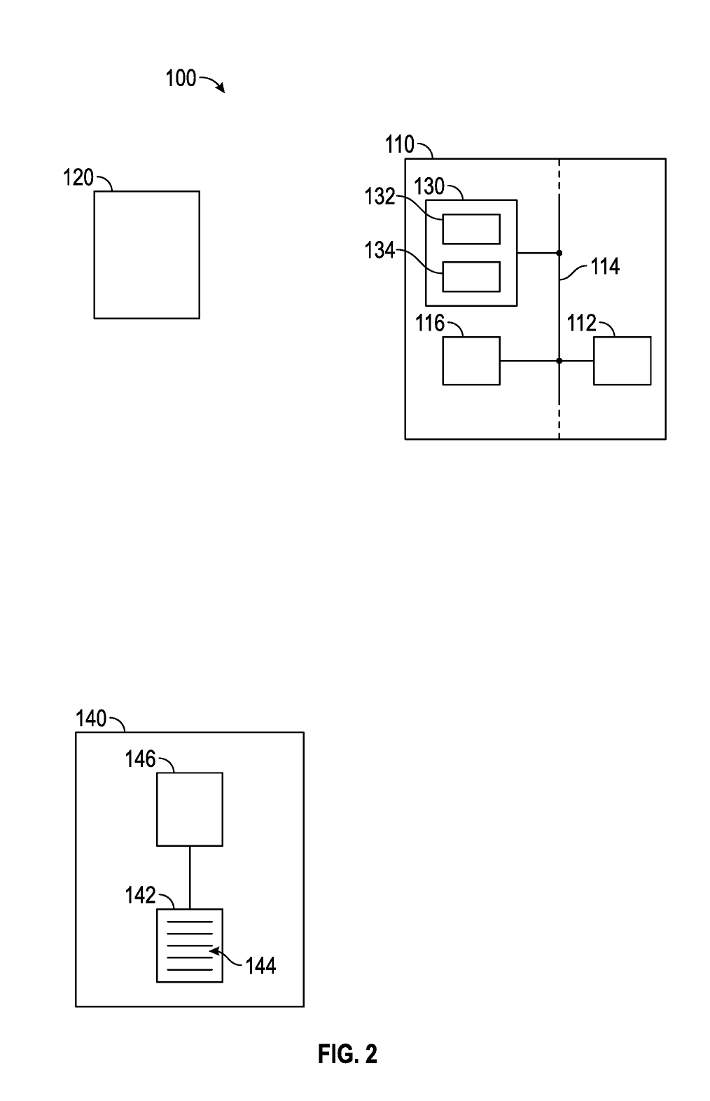

With reference to FIGS. 2-5, there is shown a non-limiting example of a system 100 for fueling a vehicle 110 with a fuel delivery service 120. It should be appreciated that the overall architecture, setup and operation, as well as the individual components of the illustrated system 100 are merely exemplary and that differently configured systems may also be utilized to implement the examples of the system 100 disclosed herein. Thus, the following paragraphs, which provide a brief overview of the illustrated system 100, are not intended to be limiting.

The system 100 for fueling a vehicle 110 with a fuel delivery service 120 generally includes a telematics unit 130 and a remote server 140. As shown in FIG. 2, telematics unit 130 adapted for installation on the vehicle 110 and configured to determine a fuel level of the vehicle 110 and transmit a vehicle fueling request to the remote server 140 based on the fuel level of the vehicle 110. In a non-limiting example, the telematics unit is in communication with a vehicle communications bus 114. Additional vehicle components such as a vehicle control module 112 and a vehicle lock system 116 are also in communication with the vehicle communications bus 114. Typically, the vehicle communications bus 114 allows any number of vehicle systems to communicate over the bus 114. One skilled in the art will appreciate that while not shown herein, any number of additional vehicle systems may be in communication with the telematics unit 130 via the vehicle communications bus 114.

The telematics unit 130 has a communication module 132 that is configured to communicate with the remote server 140 over a wireless communication channel. In a non-limiting example, the wireless communication channel is a wireless data channel, such as those used by mobile phones to access the Internet, however the specific protocol used is not contemplated by the present disclosure.

The telematics unit 130 further includes a processor module 134 configured to carry out the processing requirements of the telematics unit 130. The term “module” as used herein refers to a combination of hardware, software, and/or firmware. In a non-limiting example, the processor module 134 includes an integrated circuit associated with non-transitory medium to store code to be executed by the integrated circuit. In a non-limiting example, the processor module 134 determines the fuel level of the vehicle 112 and generates the vehicle fueling request to be transmitted by the communication module 132.

In a non-limiting example, the vehicle fueling request includes additional vehicle information pertaining to the current state or previous usage of the vehicle. For example, the telematics unit can transmit additional vehicle information relating to the mileage of the vehicle 110, the current location of the vehicle 110, where the vehicle 110 was driven, the fuel economy of the vehicle 110, etc., such that the need for fuel delivery can be accurately determined. One skilled in the art will appreciate that additional information about the vehicle 110 not recited herein may be communicated by the telematics unit 130 to the remote server 140.

The remote server 140 has a database 142 of vehicle scheduling information 144. The remote server 140 is configured to transmit a fueling request to the fuel delivery service 120. The fueling request is transmitted by the remote server 140 based on the vehicle fueling request from the telematics unit 130 and the vehicle scheduling information 144. The term “server,” as used herein, generally refers to an electronic component, as is known to those skilled in the art, such as a computer program or a machine that waits for requests from other machines or software (clients) and responds to them. In a non-limiting example, the remote server 140 waits for a vehicle fueling request from the telematics unit 130. The remote server 140 then communicates with the fuel delivery service 120 to transmit the fueling request. In a non-limiting embodiment, the vehicle scheduling information 144 corresponds to the vehicle 110.

The remote server 140 further includes a server communication module 146 that is configured to allow the remote server 140 to receive communications from the telematics unit 130 and further transmit the fueling request to the fuel delivery service 120. In a non-limiting example, the communication module 146 is configured to connect the remote server 140 to the Internet.

The database 142 has the vehicle scheduling information 144. The vehicle scheduling information 144 is the information used to manage the rental or reservation of the vehicle 110. In a non-limiting example, the vehicle scheduling information 144 includes a detailed vehicle schedule. In a non-limiting embodiment, the detailed vehicle schedule includes a previous reservation duration, a future reservation duration, a previous reservation mileage, a future reservation mileage, a current vehicle location, a future vehicle location, a future vehicle idle time, or a combination thereof. In a non-limiting example, the scheduling information 144 generally relates to times when the vehicle 110 is reserved by a customer or available to be reserved. In a non-limiting example, the vehicle scheduling information 142 generally includes information relating to a plurality of vehicles 110 such as how long the vehicle 110 was rented, how long is the next rental of the vehicle 110, where the vehicle 110 is located, etc., so that the fueling request is sent to the fuel delivery service 120 based on the vehicle scheduling information 144 corresponding to the vehicle 110.

The vehicle scheduling information 144 allows the remote server 140 to determine when the vehicle 110 will be available to receive the fuel from the fuel delivery service 120 by considering factors such as when the vehicle 110 will be idle, where it will be located, and can further transmit the fueling request based on future usage predictions. In a non-limiting example, the remote server 140 can transmit the fueling request to the fuel delivery service 120 and schedule the fuel delivery so that the vehicle 110 is refueled between reservations, after a long rental in which the vehicle 110 was driven more than a predetermined number of miles, or before a reservation which the vehicle 110 may not have enough fuel to complete. The vehicle information transmitted by the telematics unit 130 may further supplement the vehicle scheduling information to allow the remote server 140 to identify a suitable time to schedule the refueling from the fuel delivery service 120.

The remote server 140 transmits the fueling request to the fuel delivery service 120 based on the vehicle fueling request from the telematics unit 130 and the vehicle scheduling information 144. In a non-limiting example, the fueling request includes at least one of an amount of fuel needed, a type of fuel, a delivery timeframe, a location of the vehicle 110, a description of the vehicle 110, or a combination thereof. The description of the vehicle 110 can include the make, model, license plate, color, etc., such that the fuel delivery company 120 can identify the vehicle 110.

As detailed above, typically the individual customer needs to specify to the fuel delivery service 120 how much fuel they need, when to deliver the fuel, etc., which is both time consuming for the customer and can lead to improperly fueled vehicles 110. Having the remote server 140 provide the information required for the fuel delivery directly to the fuel delivery service 120 helps ensure that the proper vehicle information is conveyed to the fuel delivery service 120. In addition, the remote server 140 can transmit the fueling request to the fuel delivery service 120 to refuel more than one vehicle 110. In a non-limiting example, the remote server 140 transmits the fueling request when a predetermined number of vehicles 110 need fueling, when a predetermined number of vehicles 110 are in the same location, or at a time that minimizes the service fee charged by the fuel delivery service 120. One skilled in the art will appreciate that the vehicle scheduling information 144 of a plurality of vehicles 110 can be used to identify timeframes to more efficiently deliver fuel to more than one vehicle 110 at once to reduce the overall fee charged by the fuel delivery service 120.

When the fuel delivery service 120 receives the fueling request from the remote server 140, the fuel delivery service 120 brings a fuel tank to the vehicle 110 and refuels the vehicle 110 according to the fueling request. In a non-limiting embodiment, the telematics unit 130 is configured transmit a confirmation to the remote server 140 when the fuel delivery service 120 completes the fueling request. The telematics unit 130 can transmit the confirmation based on the fuel level of the vehicle 110, confirming that the requested amount of fuel was delivered to the vehicle 110.

Many vehicles 110 have locking fuel doors that prohibit access to the fuel tank when the vehicle is locked 110. The fuel delivery service 120 is unable to deliver fuel to a locked vehicle, however, it is not practical for customers to leave the vehicle 110 unlocked. Accordingly, in a non-limiting example, the telematics unit 130 is configured to unlock the vehicle 110 during a fuel delivery timeframe, thus allowing the fuel delivery service 120 to access the fuel tank. In a non-limiting example, the telematics unit 130 is configured to lock the vehicle 110 when the fuel delivery is complete or at the end of the fuel delivery timeframe. In this way, the vehicle 110 is only unlocked during the scheduled fuel delivery timeframe and is then locked back up when either the fuel delivery is complete, or when the fuel delivery timeframe has ended.

In a non-limiting embodiment, the vehicle fueling request is transmitted by the telematics unit 130 based on a customer fueling request. For example, a customer may have driven the vehicle 110 further than anticipated and requires fuel for the vehicle 110. The customer could request a fuel delivery through an in-vehicle interface such as an infotainment screen or through an application on a mobile device. In a non-limiting example, a customer fueling request is immediately forwarded to the fuel delivery service 120.

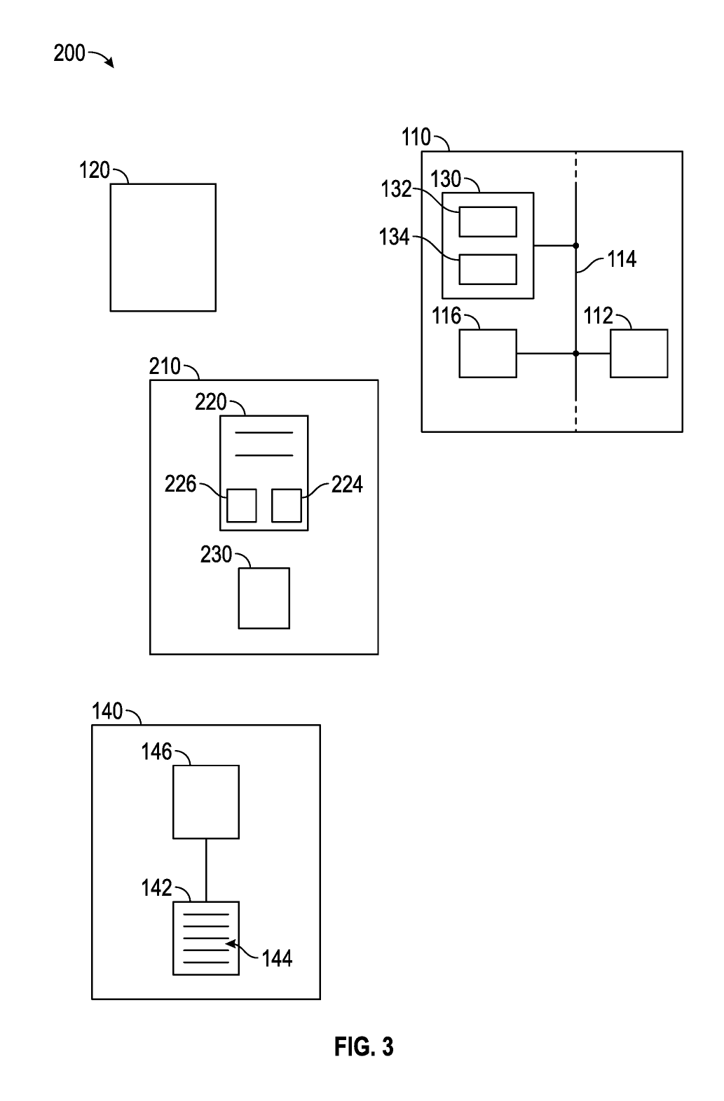

With reference now to FIG. 3 and with continued reference to FIG. 2, there is shown a non-limiting example of a system 200 for fueling a vehicle 110 with a fuel delivery service 120. It should be appreciated that the overall architecture, setup and operation, as well as the individual components of the illustrated system 200 are merely exemplary and that differently configured systems may also be utilized to implement the examples of the system 200 disclosed herein. Thus, the following paragraphs, which provide a brief overview of the illustrated system 200, are not intended to be limiting. As similar components are used in the system 200 relative to the system 100, similar reference numerals will be used and the description of system 200 will focus on the differences relative to the system 100.

System 200 further includes a mobile device 210 that is configured to communicate with the remote server 140. The mobile device 210 is used by the fuel delivery service 120 to provide detailed vehicle information to the deliverer and also provide temporary or one time vehicle access privileges to the fuel delivery service 120. The mobile device 210 is further configured to run an application 220 that is configured to receive the fueling request and a vehicle action 224, 226 from the remote server 140. In a non-limiting example, the application 220 displays details relating to the fueling request 222 such as the vehicle 110 make, model, color, etc., and the details relating to the fueling request such as the quantity of fuel, type, and delivery time.

In a non-limiting example, the application 220 further displays vehicle actions 224, 226 on the mobile device 210. The vehicle actions 224, 226, are transmitted to the application 220 from the remote server 140 and allow for the fuel delivery service 120 to access the vehicle 110. The vehicle actions 224, 226 are enabled by the telematics unit 130. In a non-limiting example, the vehicle actions 224, 226 include a vehicle fueling action that allow the fuel delivery service 120 to unlock the vehicle 110 doors, open a garage with the vehicle 110, lock the vehicle 110 doors, or start and operate the vehicle 110 without the vehicle's 110 keys. If, for example, the vehicle 110 is located inside a garage, the vehicle action 224, 226 can allow the fuel delivery service 120 to instruct the telematics unit 130 to open the garage with the vehicle's 110 on board garage door opener. In another example, in the event that the vehicle 110 needs to be moved to a level surface or to an approved location to complete refueling, the vehicle actions 224, 226 can be used to operate the vehicle 110 for a specific amount of time and within a specific area using a geo-fence. In this way, the remote server 140 can provide the application with specific vehicle actions 224, 226 to be enabled by the telematics unit 130 and allow the fuel delivery service 120 to have temporary access to the vehicle 110 as needed without using the vehicle's 110 key or requiring the vehicle 110 to be left unlocked.

In a non-limiting embodiment, the mobile device 210 further includes communications module 230 that is configured to communicate with the telematics unit 130 over a communication channel. In a non-limiting embodiment, the communication channel is a wireless protocol and includes a Bluetooth protocol, a near field communication protocol, a Wi-Fi protocol, a cellular network protocol, or a combination thereof. Accordingly, in this embodiment, the communication module 132 is similarly configured to allow the telematics unit 130 to communicate with the mobile device 210. In this way, the mobile device 210 is configured to communicate directly with the telematics unit 130 and provide the telematics unit 130 with the vehicle actions 224, 226 directly.

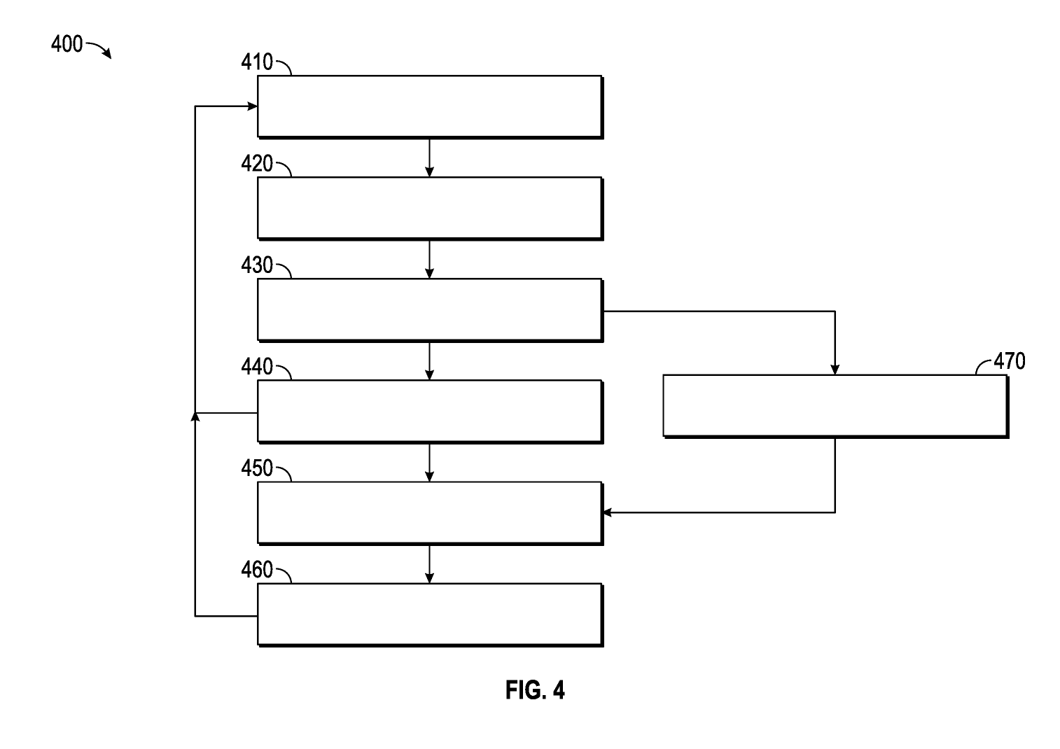

Referring now to FIG. 4, and with continued reference to FIGS. 2-3, a flowchart illustrates a method 400 for fueling a vehicle with a fuel delivery service in accordance with the present disclosure. In a non-limiting embodiment, the method 400 is performed by the systems 100, 200 as detailed above. As can be appreciated in light of the disclosure, the order of operation within the method 400 is not limited to the sequential execution as illustrated in FIG. 4, but may be performed in one or more varying orders as applicable and in accordance with the requirements of a given application.

In various exemplary embodiments, the method 400 is run based on predetermined events, and/or can run continuously during operation of the systems 100, 200. The method 400 starts at 410 with monitoring, by a telematics unit on the vehicle, a fuel level of the vehicle. In a non-limiting embodiment, the telematics unit 130 on the vehicle 110 monitors the fuel level of the vehicle 110 of the previously discussed systems 100, 200.

At 420, the method 400 transmits, by the telematics unit, a vehicle fueling request to a remote server based on the fuel level of the vehicle. In a non-limiting embodiment, the telematics unit 130 transmits the vehicle fueling request to the remote server 140 based on the fuel level of the vehicle 110 of the previously discussed systems 100, 200.

At 430, the remote server receives the vehicle fueling request. In a non-limiting embodiment, the remote server 140 receives the vehicle fueling request from the telematics unit 130 of the previously discussed systems 100, 200.

At 440, the remote server transmits a fueling request to the fuel delivery service. The fueling request is based on the vehicle fueling request and a vehicle scheduling information. In a non-limiting embodiment, the remote server 140 transmits the fueling request to the fuel delivery service 120 based on the vehicle fueling request and the vehicle scheduling information 144 of the previously discussed systems 100, 200. The method 400 then proceeds to 410 and monitors the fuel level of the vehicle.

In a non-limiting embodiment, the method 400 further includes 450 and the telematics unit locks the vehicle when the fuel delivery service completes the fueling request based on the fuel level. In a non-limiting embodiment, the telematics unit 130 locks the vehicle 110 when the fuel delivery service 120 completes the fueling request based on the fuel level of the previously discussed systems 100, 200.

In a non-limiting embodiment, the method 400 further includes 460 the telematics unit transmits a confirmation to the remote server. In a non-limiting embodiment, the telematics unit 130 transmits the confirmation to the remote server 140 of the previously discussed systems 100, 200. The method 400 then proceeds to 410 and monitors the fuel level of the vehicle.

In a non-limiting embodiment, the method 400 further includes 470 and the remote server waits for a predetermined number of vehicle fueling requests before transmitting the fueling request to the fuel delivery service. In a non-limiting embodiment, the remote server 140 waits until a predetermined number of vehicle fueling requests are received before transmitting the fueling request to the fuel delivery service 120. The method 400 then proceeds to 440 and transmits the fuel request to the fuel delivery service.

In a non-limiting embodiment, the fueling request transmitted by the remote server further includes at least one of an amount of fuel, a type of fuel, a delivery timeframe, a location of the vehicle, a description of the vehicle, or a combination thereof. In a non-limiting embodiment, the telematics unit transmits the vehicle fueling request to the remote server based on a customer fueling request. In a non-limiting embodiment, the vehicle scheduling information includes a detailed vehicle schedule. In a non-limiting embodiment, the detailed vehicle schedule includes a previous reservation duration, a future reservation duration, a previous reservation mileage, a future reservation mileage, a current vehicle location, a future vehicle location, a future vehicle idle time, or a combination thereof.

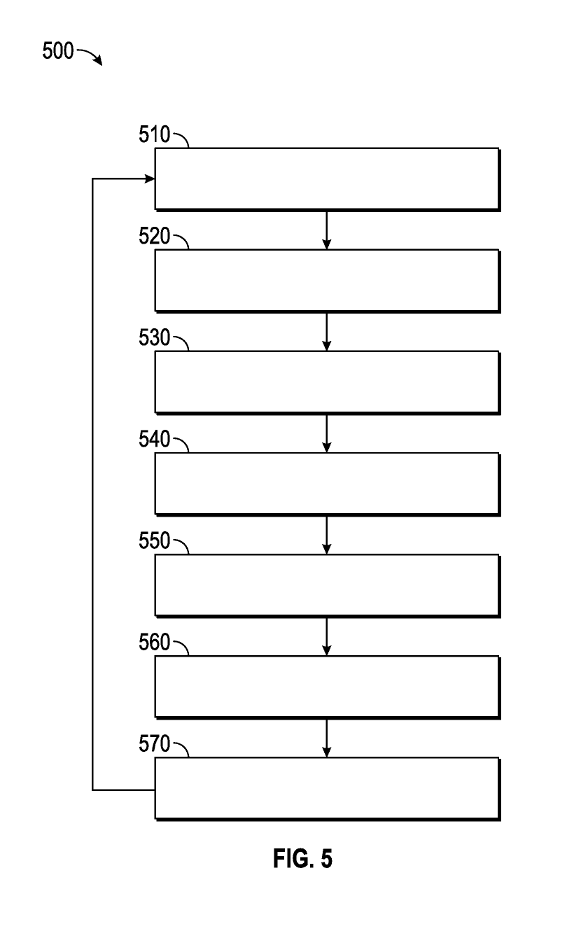

Referring now to FIG. 5, and with continued reference to FIGS. 2-4, a flowchart illustrates a method 500 for fueling a vehicle with a fuel delivery service in accordance with the present disclosure. In a non-limiting embodiment, the method 500 is performed by the system 200 as detailed above. As can be appreciated in light of the disclosure, the order of operation within the method 500 is not limited to the sequential execution as illustrated in FIG. 5, but may be performed in one or more varying orders as applicable and in accordance with the requirements of a given application.

In various exemplary embodiments, the method 500 is run based on predetermined events, and/or can run continuously during operation of the system 200. The method 500 starts at 510 with monitoring, by a telematics unit on the vehicle, a fuel level of the vehicle. In a non-limiting embodiment, the telematics unit 130 on the vehicle 110 monitors the fuel level of the vehicle 110 of the previously discussed system 200.

At 520, the method 500 transmits, by the remote server, the fueling request based on the vehicle fueling request and the vehicle scheduling information. In a non-limiting embodiment, the remote server 140 transmits the fueling request based on the vehicle fueling request and the vehicle scheduling information 144 of the previously discussed system 200.

At 530, the remote server receives the vehicle fueling request. In a non-limiting embodiment, the remote server 140 receives the vehicle fueling request from the telematics unit 130 of the previously discussed system 200.

At 540, the method 500 transmits, by the remote server, the fueling request and a vehicle action to a mobile device. In a non-limiting embodiment, the remote server 140 transmits the vehicle fueling request and the vehicle actions 224, 226 to the mobile device 210 of the previously discussed system 200.

At 550, the method 500 displays, by an application on the mobile device, the fueling request and the vehicle action. In a non-limiting embodiment, the application 220 on the mobile device 210 displays the details relating to the fueling request 222 and the vehicle actions 224, 226 of the previously discussed system 200.

At 560, the method 500 transmits, by the mobile device, the vehicle action to the telematics unit. In a non-limiting embodiment, the mobile device 210 transmits the vehicle actions 224, 226 to the telematics unit 130 of the previously discussed system 200.

At 570, the method includes enabling, by the telematics unit, the vehicle action. In a non-limiting embodiment, the telematics unit 130 enables the vehicle actions 224, 226 of the previously discussed system 200. The method then proceeds to 510 and monitors the fuel level of the vehicle.

In a non-limiting embodiment, the vehicle actions include vehicle fueling actions including a garage door access, a limited vehicle unlock, a temporary vehicle operation range, or a combination thereof. In a non-limiting embodiment, the mobile device communicates with the telematics unit over a communication channel including a Bluetooth protocol, a near field communication protocol, a wireless network protocol, a wireless data protocol, or a combination thereof.

While various exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

What is claimed is:

1. A system for fueling a vehicle with a fuel delivery service, the system comprising:
a telematics unit adapted for installation on the vehicle and configured to determine a fuel level of the vehicle; and
a remote server having a database of vehicle scheduling information, the remote server configured to transmit a fueling request to the fuel delivery service,
wherein the telematics unit is further configured to transmit a vehicle fueling request to the remote server based on the fuel level of the vehicle, and
wherein the remote server is configured to transmit the fueling request based on the vehicle fueling request and the vehicle scheduling information.

2. The system of claim 1, wherein the fueling request to the fuel delivery service includes at least one of: an amount of fuel, a type of fuel, a delivery timeframe, a location of the vehicle, a description of the vehicle, or a combination thereof.

3. The system of claim 1, further comprising:
a mobile device configured to communicate with the remote server; and
an application on the mobile device, the application configured to receive the fueling request and a vehicle action from the remote server,
wherein the telematics unit is further configured enable the vehicle action.

4. The system of claim 3, wherein the vehicle action comprises a vehicle fueling action.

5. The sign of claim 3, wherein the mobile device is further configured to communicate with the telematics unit over a communication channel.

6. The system of claim 1, wherein the vehicle fueling request is based on a customer fueling request.

7. The system of claim 1, wherein the telematics unit is further configured to lock the vehicle and transmit a confirmation to the remote server when the fuel delivery service completes the fueling request based on the fuel level.

8. The system of claim 1, wherein the vehicle scheduling information includes a detailed vehicle schedule.

9. The system of claim 1, wherein the fueling request is further based on a plurality of vehicle fueling requests and a corresponding plurality of vehicle scheduling information.

10. The system of claim 9, wherein the remote server transmits the fueling request when a predetermined number of vehicles at a location transmit vehicle fueling requests to the remote server.

11. A method for fueling a vehicle with a fuel delivery service, the method comprising:
monitoring, by a telematics unit on the vehicle, a fuel level of the vehicle;
transmitting, by the telematics unit, a vehicle fueling request to a remote server based on the fuel level of the vehicle;
receiving, by the remote server, the vehicle fueling request;
transmitting, by the remote server, a fueling request to the fuel delivery service, wherein the fueling request is based on the vehicle fueling request and a vehicle scheduling information corresponding to the vehicle.

12. The method of claim 11, wherein transmitting, by the remote server, the fueling request further includes at least one of: an amount of fuel, a type of fuel, a delivery timeframe, a location of the vehicle, a description of the vehicle, or a combination thereof.

13. The method of claim 11, further comprising:
transmitting, by the remote server, the fueling request and a vehicle action to a mobile device;
displaying, by an application on the mobile device, the fueling request and the vehicle action;
transmitting, by the mobile device, the vehicle action to the telematics unit; and
enabling, by the telematics unit, the vehicle action.

14. The method of claim 13, wherein the vehicle action comprises a vehicle fueling action.

15. The method of claim 13, wherein the transmitting, by the mobile device, is over a communication channel.

16. The method of claim 11, further comprising:
transmitting, by the telematics unit, the vehicle fueling request to the remote server based on a customer fueling request.

17. The method of claim 11, further comprising:
locking the vehicle, by the telematics unit, when the fuel delivery service completes the fueling request based on the fuel level; and
transmitting, by the telematics unit, a confirmation to the remote server.

18. The method of claim 11, wherein the vehicle scheduling information includes a detailed vehicle schedule.

19. The method of claim 1, further comprising:
receiving, by the remote server, a plurality of vehicle fueling requests; and
transmitting, by the remote server, the fueling request to the fuel delivery service based on a corresponding plurality of vehicle scheduling information.

20. The method of claim 19, further comprising:
waiting, by the remote server, until a predetermined number of vehicle fueling requests have been received; and
transmitting, by the remote server, the fueling request to the fuel delivery service based on the corresponding plurality of vehicle scheduling information.
